(19) United States
(12) Patent Application Publication
(10) Pub. No.: US 2017/0365210 A1
(43) Pub. Date: Dec. 21, 2017

(54) GARMENT DISPLAY APPARATUS, DISPLAYABLE GARMENT AND MOBILE TERMINAL

(71) Applicant: MINGJIN WANG, Shenzhen City (CN)

(72) Inventor: MINGJIN WANG, Shenzhen City (CN)

(21) Appl. No.: 15/626,071

(22) Filed: Jun. 16, 2017

(30) Foreign Application Priority Data
Jun. 17, 2016 (CN) 201610439363.4

(51) Int. Cl. G09G 3/20; A41B 1/08; G06F 3/041; A41D 1/00; A43B 3/00

(52) U.S. Cl. CPC G09G 3/2096; A41D 1/002; A43B 3/0005; G06F 3/0412; A41B 1/08; G09G 2354/00; G09G 2370/16; G09G 2380/02; G06F 2203/04102

(57) ABSTRACT

A garment display apparatus, a displayable garment and a mobile terminal are provided. The garment display apparatus includes a flexible display screen attached on an external surface of a garment, and a controller configured to acquire a display signal and control the flexible display screen to display an image corresponding to the display signal based on the display signal. The garment displayed by the display apparatus may provide a change to a style of the garment by displaying different images thereof.

### CROSS-REFERENCE TO RELATED APPLICATIONS

This application claims all benefits accruing under 35 U.S.C. §119 from China Patent Application No. 201610439363.4, field on Jun. 17, 2016 in the China Intellectual Property Office, the contents of which are hereby incorporated by reference.

### TECHNICAL FIELD

The present disclosure generally relates to the technical field of garment, and in particular relates to a garment display apparatus, a displayable garment and a mobile terminal.

### BACKGROUND

In daily life, a style of a garment (including versions, colors, patterns on surfaces of the garment, or the like) will be specifically designed, in order to make the garment to be dressed better designed.

However, at present, a style of each garment is fixed, and thus a user usually buys lots of garments in different styles, in order to meet special demands on different occasions or in different environments. Furthermore, when the user needs to attend different occasions on one day, he/she needs to change many sets of garments in one day, which is troublesome and wasteful for the user.

### SUMMARY

Embodiments of the present provide a garment display apparatus, a displayable garment and a mobile terminal, which can solve the technical problems of unchanged styles of the garment in the art.

In accordance with an aspect of the present disclosure, a garment display apparatus, and the garment display apparatus comprising: a flexible display screen attached on an external surface of a garment; and a controller configured for acquiring a display signal and controlling the flexible display screen to display an image corresponding to the display signal based on the display signal.

In accordance with another aspect of the present disclosure, a displayable garment is provided, wherein the displayable garment has a garment display apparatus provided thereon, and the garment display apparatus comprises a flexible display screen attached on an external surface of a garment; and a controller configured for acquiring a display signal and controlling the flexible display screen to display an image corresponding to the display signal based on the display signal.

In accordance with a further aspect of the present disclosure, a mobile terminal, the mobile terminal comprising: a second communication module connected to a garment display apparatus; and a processor configured for sending display data to the display apparatus of the garment via the second communication module.

The display apparatus of the present disclosure includes a flexible display screen and a controller, wherein the flexible display screen is attached to the external surface of the garment; the controller acquires the display signal, and controls the flexible display screen to display the image corresponding to the display signal based on the acquired display signal. The controller may control the flexible display screen to display different images based on different display signals, while the flexible display screen is attached on the external surface of the garment. Therefore, the style of the garment may be changed.

### BRIEF DESCRIPTION OF THE DRAWINGS

FIG. 1 is a schematic view illustrating an embodiment of a garment display apparatus according to the present disclosure.

FIG. 2 is a schematic view illustrating an application of the garment display apparatus shown in FIG. 1 to a shoe.

FIG. 3 is a schematic view illustrating an application of the garment display apparatus shown in FIG. 1 to a shirt.

FIG. 4 is a structural view illustrating an embodiment of a displayable garment according to the present disclosure.

FIG. 5 is a schematic view illustrating an embodiment of a mobile terminal apparatus according to the present disclosure.

### DETAILED DESCRIPTION

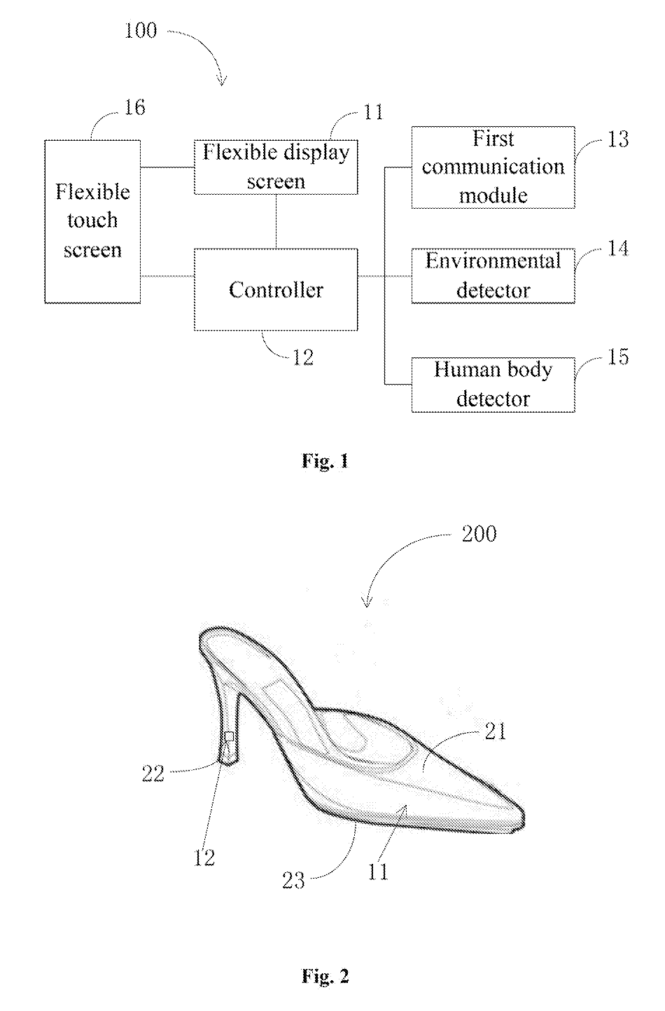

FIG. 1 is a schematic view illustrating an embodiment of a garment display apparatus according to the present disclosure. As is shown in FIG. 1, the display apparatus 100 may include a flexible display screen 11 and a controller 12.

The display apparatus 100 may be applied to a garment. The garment may be a single item for daily wearing such as a cap, a shirt, a glove, a tie, a bow tie, trousers, a shoe, a belt, a handbag, or the like. It is possible for the garment to be a certain single item; however, it may also be possible for the garment to be a plurality of single items. The flexible display screen 11 of the display apparatus 100 may be attached onto an external surface of the garment for displaying different images, in such a way that it is possible to change the style of the garment.

The flexible display screen 11 may be attached onto an external surface of the garment. The attachment may be achieved in many ways such as adhering, stitching, completely attaching, partially attaching, or the like. With the development of the flexible display screen technology, the flexible display screen 11 becomes thinner and thinner, and can be freely bent as if papers. When completely attached on the external surface of the garment, the flexible display screen 11 may be attached on the external surface of the garment in any shape. Further, the flexible display screen 11 may be deformed along with shape deformation of the external surface of the garment; for example, when the flexible display screen 11 is completely attached on the external surface of the garment, the softness of the garment will not be changed.

In one embodiment, by using the flexible display screen to display, the garment may have different kinds of styles; by attaching the flexible display screen 11 on the external surface of the garment, others may directly see what the flexible display screen 11 displays. The external surface is the surface of the garment that is away from the body; correspondingly, the internal surface is the surface of the garment that is close to the body.

The controller 12 is used for controlling the flexible display screen 11 to display images. Specifically, the controller 12 acquires a display signal, and controls the flexible display screen 11 to display an image corresponding to the display signal based on the display signal. The image described here may be a static image or a dynamic image.

The controller 12 may acquire the display signal in many ways, and certain examples will be described below.

The display apparatus 100 may further comprise a first communication module 13 connected to the controller 12, and the display apparatus 100 may be connected to a mobile terminal via the first communication module 13. The mobile terminal is configured for generating the display signal.

The first communication module 13 may be implemented as a wireless connection module such as a WiFi module, a Bluetooth module, or the like, and the display apparatus 100 is connected to the mobile terminal via a wireless connection. After the mobile terminal generates a display signal, the display signal is sent to the display apparatus 100 via the wireless connection. The controller 12 of the display apparatus 100 acquires the display signal via the first communication module 13, and controls the flexible display screen 11 to display the corresponding image based on the display signal.

Further, it is also possible for the mobile terminal to generate the display signal in many ways. For example, the mobile terminal may automatically generate the display signal, that is, the mobile terminal may be triggered to automatically select a certain image itself based on a signal detected by a hardware detector, and in turn generate the display signal corresponding to the image. However, the mobile terminal may also generate the display signal artificially; that is, a user may select an image via an APP, and then an instruction of selecting the image is generated, and the mobile terminal generates a display signal corresponding to the selected image based on the instruction. In this case, it is possible for the image to be stored locally, or stored in the network cloud.

In a further embodiment, the display apparatus 100 may include an environmental detector 14 configured for acquiring environmental data. The controller 12 may acquire the display signal based on the environmental data, and in turn control the flexible display screen 11 to display the image corresponding to the environmental data based on the display signal.

The environmental detector 14 may be configured for acquiring the environmental data, and generally arranged on the external surface of the garment. The environmental detector 14 may be implemented as a temperature detector, a light detector, a humidity detector, a camera device, a positioning device, or the like.

When the environmental detector 14 is a temperature detector, it can detect the temperature in the environment. In this case, different preset patterns corresponding to different environmental temperature may be set. When a certain environmental temperature is detected, the preset pattern corresponding thereto may be selected to display. In specific, when it is cold, the flexible display screen 11 may be controlled to display the pattern in dark color. Likewise, the light detector or the humidity detector may have similar configurations.

When the environmental detector 14 is a camera device, it can take a photograph of surroundings, and analyze contents in the photograph; in this way, the current scene will be known. In this case, the user needs to take some distinctive photographs artificially; for example, when corporate logos or office tables have been photographed, it can be known that the user is in a business occasion at present; however, when dining tables or wines have been photographed, it can be known that the user is in a restaurant at present. It may be also possible for the camera device to automatically photograph for a period of time, in order to acquire more data, and thus it is possible to determine the current occasion more accurately. After the occasion is known, it is possible to select and display the preset image corresponding to the occasion.

It is also possible to display different preset images corresponding to different occasions by means of the positioning device. That is, the environmental detector 14 is now a positioning device. The positioning device can get to know which hotel or which office building the user is located in, and further determine the current occasion.

The environmental detector 14 may be the temperature detector, a light detector, a humidity detector, a camera device, a positioning device, or any combination thereof.

After the environmental detector 14 acquires the environmental data, the controller 12 acquires the display signal based on the environmental data. In one embodiment, it is possible for the controller 12 to acquire the display signal from the display apparatus 100 itself based on the environmental data; in this case, the display apparatus 100 stores locally the display signal corresponding to the environmental data.

In a further embodiment, it is also possible for the controller 12 to acquire the display signal from other apparatuses based on the environmental data. In that case, the display apparatus 100 may include the first communication module 13, and is connected to the mobile terminal via the first communication module 13. After acquiring the environmental data, the environmental detector 14 sends the environmental data to the mobile terminal. The mobile terminal generates the display signal corresponding to the environmental data based on the environmental data. As is described above, the mobile terminal may generate the display signal automatically or artificially. After that, the controller 12 acquires the display signal from the mobile terminal.

The first communication module 13 may be implemented as a wireless connection module; the display apparatus 100 may be directly connected to the internet via the wireless connection module, and the controller 12 may acquire the display signal corresponding to the environmental data from the database of the Internet based on the environmental data. In this case, the database may be a cloud database established by an individual or by the public, and preset images and the correspondence between the preset images and the environmental data are stored therein. In order to ensure that the data is safe and valid, adaptation verification may be performed when the display apparatus 100 is connected to the database for the first time.

After acquiring the display signal, the controller 12 controls the flexible display screen 11 to display the preset image corresponding to the environmental data based on the display signal.

The display apparatus 100 may further include a human body detector 15 configured for acquiring human body data; the controller 12 acquires the display signal based on the human body data, the controller 12 acquires the display signal based on the human body data and controls the flexible display screen 11 to display the preset image corresponding to the human body data based on the display signal.

The human body detector 15 is configured for acquiring the human body data, and may be positioned on the internal surface of the garment in general since the human body detector 15 needs to detect skin, heart rate, temperature, blood pressure of the human body, or the like. Correspondingly, the human body detector 15 may be implemented as a skin detector, a heart rate detector, a temperature detector, a blood pressure detector, or any combination thereof.

When the human body detector 15 is a skin detector, the skin tone of the human body can be detected. In this case, different preset patterns corresponding to different skin tones may be set. When a certain skin tone is detected, the corresponding preset pattern may be selected to display. For example, when the skin tone is warm-toned, the flexible display screen 11 is controlled to display a warm-toned pattern.

When the human body detector 15 is a heart rate detector, the heart rate can be detected, and the mood of the user can be determined based on the heart rate. In this case, different preset patterns corresponding to different moods may be set. When the user is determined to be in a certain mood, the corresponding preset pattern may be selected to display. The human body detector 15 may meanwhile further include a temperature detector or a blood pressure detector, and may detect the heart rate, the temperature, and the blood pressure at the same time. In this way, the mood determined by the human body detector is more accurate.

After the human body detector 15 acquires the human body data, the controller 12 acquires the display signal based on the human body data. Similar to the situation of acquiring the display signal based on the environmental data, the controller 12 may also acquire the display signal from the display apparatus 100 itself based on the human body data, and it will not be repeated any more here.

The display apparatus 100 may further include a flexible touch screen 16 arranged on a display surface of the flexible display screen 11 and configured for receiving a touch instruction. The controller 12 may be connected to the flexible touch screen, acquire the touch instruction, and perform corresponding operations on the flexible display screen 11 based on the touch instruction.

With the development of technology, the flexible touch screen 16 may be freely bent. The flexible touch screen 16 may be arranged on the display surface of the flexible display screen 11, and attached onto the external surface of the garment along with the flexible display screen 11, without limiting the shape of the garment.

The user may input touch operations on the flexible touch screen 16, and thus the touch instruction may be generated. The controller 12 may acquire the touch instruction, control and perform corresponding operations on the flexible display screen 11, and thus visual interaction may be achieved via the flexible display screen 11.

The user may select the image to be displayed via the flexible touch screen 16 and the flexible display screen 11, and thus a display image instruction may be generated; the controller 12 then controls the flexible display screen 11 to display the selected image based on the instruction.

The ways in which the controller 12 acquires the display signal described above do not conflict with each other, and thus these ways may exist in the display apparatus 100 at the same time, or parts of them may be selected to use in the display apparatus 100 as required. When the controller 12 of the display apparatus 100 uses a plurality of ways to acquire the display signal, these ways are implemented at the same time. In this case, priorities may be set; for example, the way of acquiring the human body data may have the highest priority, and followed by the way of acquiring the display signal based on the environmental data. The priorities of these ways may be fixedly set, or may be customized by the user himself/herself.

The display apparatus 100 shown in FIG. 1 comprises the first communication module 13, the environmental detector 14, the human body detector 15 and the flexible touch screen 16. However, in other embodiments, the display apparatus may comprise some components selecting from the group of components consisting of the first communication module 13, the environmental detector 14, the human body detector 15 and the flexible touch screen 16.

The display apparatus 100 may further comprise a power source. The power source may be a thin-film battery which can be attached onto the surface of the garment.

The display apparatus 100 described above may be applied to the garment. In this embodiment, the display apparatus 100 is applied to a shoe, and FIG. 2 is a schematic view illustrating the application of the garment display apparatus shown in FIG. 1 to the shoe.

The garment includes a shoe 200. The flexible display screen 11 is attached on an upper 21 of the shoe 200, and the controller 12 is arranged in a heel 22 or a sole 23 of the shoe 200. It is conceivable that the power source of the display apparatus 100 may also be arranged in the heel 22 or the sole 23.

The manufacturing of the shoe 200 generally includes the following processes: attaching the flexible display screen 11 on the upper 21 of the shoe 200, and arranging the controller 12 in the heel 22 or the sole 23 of the shoe 200. That is, the products leaving the factory is the shoe 200 having the display apparatus 100 arranged therein.

The shoe 200 may be manufactured by using the 3D printing technology to form a main body of the shoe, and a cavity having an opening is formed in the heel 22 or the sole 23. After that, the flexible display screen 11 of the display apparatus 100 is attached on the upper 21 of the shoe 200, and the controller 12 is arranged in the cavity of the heel 22 or the sole 23. Finally, the opening of the cavity is sealed.

The flexible display screen 11 may be attached to the whole upper 21, and the display content of the flexible display screen 11 is the appearance of the shoe 200. The shoe shown in FIG. 2 is a high-heeled shoe, and the controller 12 is in generally arranged in the heel 22. However, for a flat shoe, the controller 12 may be arranged in the sole 23. Connecting wires between the controller 12 and the flexible display screen 11 may be embedded in the upper 21 or the sole 23.

When the display apparatus 100 further comprises the first communication module 13, the environmental detector 14, the human body detector 15 or the flexible touch screen 16, generally, the first communication module 13 is arranged in the heel 22 or the sole 23, the environmental detector 14 is arranged on the upper 21, and the flexible touch screen 16 is arranged on the display surface of the flexible display screen 11.

In general, there is no need to arrange the human body detector 15 on the display apparatus 100 when the display apparatus 100 is applied to the shoe. The display apparatus 100 having the human body detector 15 is more widely used in the clothes or the gloves.

When the display apparatus 100 is provided with the first communication module 13, the display apparatus 100 may be connected to the mobile terminal via the first communication module 13. In this case, the user may acquire the style of the garment via the mobile terminal, and the display signal is then generated based on the style; after that, the controller 12 controls the flexible display screen 11 to display the image corresponding to the style.

In specific, after selecting the clothes and needing to select the shoes go with the clothes, the user can acquire the style of the selected clothes (including its color, pattern, or the like) via a camera of the mobile terminal. The image of the shoe 200 to be displayed is determined based on the acquired pattern, and the corresponding display signal is generated. The controller 12 may acquire the display signal from the mobile terminal via the first communication module 13, and control the flexible display screen 11 to display the image corresponding to the styles based on the display signal.

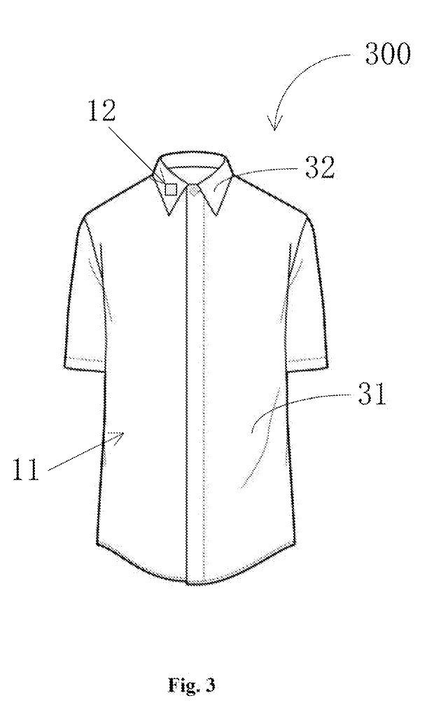

FIG. 3 is a schematic view illustrating an application of the garment display apparatus shown in FIG. 1 to a shirt. As is shown in FIG. 3, when the display apparatus 100 is used in the shirt, the garment includes a shirt 300. The flexible display screen 11 is attached on an external surface 31 of the shirt 300, while the controller 12 may be arranged under a collar 32 of the shirt 300. In other cases, it may also be possible to provide an interlining in the shirt 300 for the arrangement of the controller 12. The manufacturing and display controlling ways of the shirt 300 are similar to those of the shoe 200, and will not be repeated any more.

The display apparatus of the present disclosure includes a flexible display screen and a controller, wherein the flexible display screen is attached to the external surface of the garment; the controller may acquire the display signal in many ways, and control the flexible display screen to display the image corresponding to the display signal based on the acquired display signal. The controller may control the flexible display screen to display different images based on different display signals, while the flexible display screen is attached on the external surface of the garment. Therefore, it is possible to change the style of the garment.

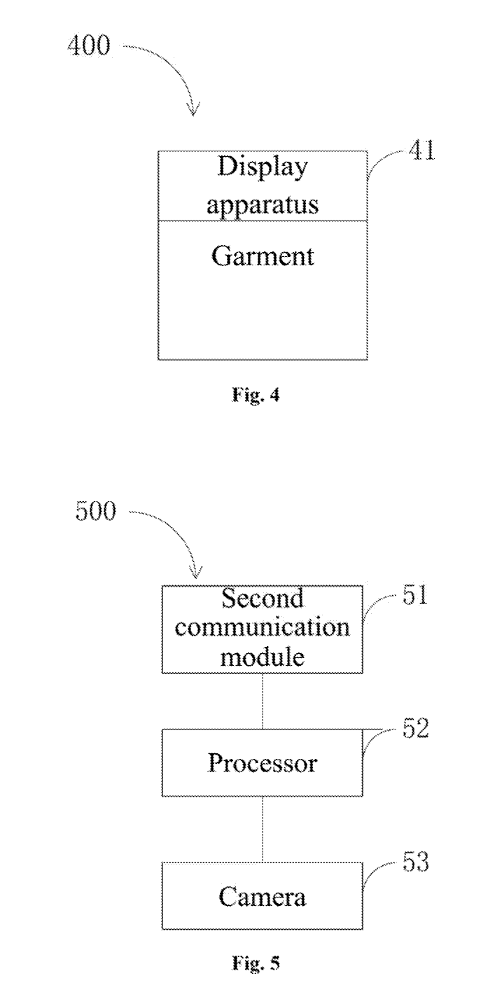

FIG. 4 is a structural view illustrating an embodiment of a displayable garment according to the present disclosure. As is shown in FIG. 4, the garment 400 of the present embodiment is provided with a display apparatus 41. The display apparatus 41 is similar to the display apparatus 100 described above, and will not be repeated any more.

The display apparatus 41 may be arranged on the garment 400 during the manufacturing processes of the garment 400. However, it is also possible that the finished garment 400 is acquired during the manufacturing processes, and the display apparatus 41 is arranged on the finished garment 400 by means of adhering, stitching, or the like.

For example, when the garment 400 is a shoe, the display apparatus 41 may be mounted on the shoe during the manufacturing processes, and the finished product leaving the factory is a shoe having the display apparatus 41 arranged therein. However, it may be also possible to manufacture the shoe and the display apparatus 41 individually, and to arrange the display apparatus on the shoe by operations (such as attaching) of the customer.

Furthermore, for the garment 400 having the display apparatus 41 arranged therein, in order to keep the garment clean, it is also possible to coat a layer of transparent nano material onto the surface of the garment 400 after the display apparatus 41 has been arranged on the garment 400. In this way, the garment is more stain-resistant.

In a further embodiment, the displayable garment of the present disclosure may be provided with the display apparatus. By displaying different image via the display apparatus, it is possible to change the style of the garment.

FIG. 5 is a schematic view illustrating an embodiment of a mobile terminal apparatus according to the present disclosure. As is shown in FIG. 5, the mobile terminal 500 of the present embodiment may comprise a second communication module 51 and a processor 52. The term “second” used in the “second communication module 51” is only used for distinguishing from the first communication module 13 of the display apparatus 100 described above, and is not used for limiting that the mobile terminal 500 includes two communication modules.

The second communication module 51 is configured for connecting to the display apparatus of the garment, and the processor 52 is configured for sending display data to the display apparatus of the garment via the second communication module 51.

The display data to be sent needs to be determined before it is sent by the processor 52 of the mobile terminal 500. The determination can be carried out in many ways.

The user inputs image selecting instruction via an input apparatus (such as a physical keyboard, a touch panel, speech recognition, or the like) of the mobile terminal, and the processor 52 acquires the display data corresponding to the selected image in response to the instruction. After that, the processor 52 may send the display apparatus to the garment automatically or based on the instruction of the user.

During the processes described above, an image database may be established in the mobile terminal 500, in such a way that the user may access to the database and select the image he/she needs. The image database may be store locally or in the cloud.

It may be also possible for the mobile terminal 500 to classify the image database, and different garments have different databases. When the mobile terminal 500 is connected to the display apparatus of the garment, the information of the garment may be acquired; that is, it can be ensured that whether the garments are clothes or other kinds of garments. After receiving the information of the garment, the mobile terminal 500 loads in or connects to the corresponding database, in such a way that the user may directly select the required pattern in the corresponding database of the clothes or the shoes.

When an environmental detector or a human body detector is arranged on the garment, the mobile terminal 500 may acquire environmental information from the environmental detector, or acquire human body data from the human body detector. The processor 52 may automatically acquire the corresponding display information based on the environmental information or the human body data, and send the display information to the display apparatus automatically or based on the user instructions.

3) The mobile terminal 500 may further comprise a camera 53 configured for acquiring external information. The processor 52 may acquire the display data corresponding to the external information based on the external information, and send the display data to the display apparatus of the garment via the second communication module 51.

The mobile terminal of the present disclosure may control the display of the display apparatus on the displayable garment, and thus it is possible to change the style of the garment.

The above description depicts merely some exemplary embodiments of the disclosure, but does not mean to limit the scope of the disclosure. Any equivalent structure or flow transformations made to the disclosure, or any direct or indirect applications of the disclosure on other related fields, shall all be covered within the protection of the disclosure.

What is claimed is:

1. A garment display apparatus, comprising:
a flexible display screen attached on an external surface of a garment; and
a controller configured to acquire a display signal and control the flexible display screen to display an image corresponding to the display signal based on the display signal.

2. The garment display apparatus according to claim 1, further comprising a communication module connected to the controller; wherein the display apparatus is connected to a mobile terminal via the communication module, and the mobile terminal is configured to generate the display signal.

3. The garment display apparatus according to claim 2, wherein the garment comprises a shoe; the flexible display screen is attached on an upper of the shoe; the controller is arranged in a heel or a sole of the shoe.

4. The garment display apparatus according to claim 2, wherein the garment comprises a shirt; the flexible display screen is attached on an external surface of the shirt, and the controller is arranged under a collar of the shirt.

5. The garment display apparatus according to claim 3, wherein the mobile terminal is configured to acquire a style of a shirt, and generate the display signal based on the style; the controller controls the flexible display screen to display the image corresponding to the style based on the display signal.

6. The garment display apparatus according to claim 1, further comprising an environmental detector configured to acquire environmental data; wherein the controller acquires the display signal based on the environmental data, and controls the flexible display screen to display a preset image corresponding to the environmental data based on the display signal.

7. The garment display apparatus according to claim 6, wherein the environmental detector is a temperature detector, a light detector, a humidity detector, a camera device, a positioning device, or any combination thereof.

8. The garment display apparatus according to claim 1, further comprising a human body detector configured to acquire human body data; wherein the controller acquires the display signal based on the human body data, and controls the flexible display screen to display a preset image corresponding to the human body data based on the display signal.

9. The garment display apparatus according to claim 8, wherein the human body detector is a skin detector, a heart rate detector, a temperature detector, a blood pressure detector, or any combination thereof.

10. The garment display apparatus according to claim 1, further comprising a flexible touch screen; wherein the flexible touch screen is arranged on a display surface of the flexible display screen and configured to receive a touch instruction; the controller is connected to the flexible touch screen, acquires the touch instruction, and performs corresponding operations on the flexible display screen based on the touch instruction.

11. A displayable garment having a garment display apparatus provided thereon, wherein the garment display apparatus comprises:
a flexible display screen attached on an external surface of the garment; and
a controller configured to acquire a display signal and control the flexible display screen to display an image corresponding to the display signal based on the display signal.

12. The displayable garment according to claim 11, wherein the garment display apparatus further comprises a communication module connected to the controller; the display apparatus is connected to a mobile terminal via the communication module, and the mobile terminal is configured for generating the display signal.

13. The displayable garment according to claim 11, wherein the garment display apparatus further comprises an environmental detector configured for acquiring environmental data; the controller acquires the display signal based on the environmental data, and controls the flexible display screen to display a preset image corresponding to the environmental data based on the display signal.

14. The displayable garment according to claim 13, wherein the environmental detector is a temperature detector, a light detector, a humidity detector, a camera device, a positioning device, or any combination thereof.

15. The displayable garment according to claim 11, wherein the garment display apparatus further comprises a human body detector configured to acquire human body data; the controller acquires the display signal based on the human body data, and controls the flexible display screen to display a preset image corresponding to the human body data based on the display signal.

16. The displayable garment according to claim 15, wherein the human body detector is a skin detector, a heart rate detector, a temperature detector, a blood pressure detector, or any combination thereof.

17. The displayable garment according to claim 11, wherein the garment display apparatus further comprises a flexible touch screen; wherein the flexible touch screen is arranged on a display surface of the flexible display screen and configured for receiving a touch instruction; the controller is connected to the flexible touch screen, acquires the touch instruction, and performs corresponding operations on the flexible display screen based on the touch instruction.

18. A mobile terminal, comprising:
a communication module connected to a garment display apparatus; and
a processor configured to send display data to the display apparatus of the garment via the communication module.

19. The mobile terminal according to claim 18, further comprising a camera configured to acquire external information; the processor acquires the display data corresponding to the external information based on the external information, and sends the display data to the display apparatus of the garment via the communication module.

20. The mobile terminal according to claim 18, further comprising an input apparatus configured to acquire image selecting instruction, and the processor configured to acquire the display data corresponding to the selected image in response to the instruction.
